(19) United States
(12) Patent Application Publication
(10) Pub. No.: US 2026/0296401 A1
(43) Pub. Date: Oct. 1, 2026

(54) Vehicle Control Device, Vehicle Control Method, and Steering System

(71) Applicant: Hitachi Astemo, Ltd., Hitachinaka-shi, Ibaraki (JP)

(72) Inventor: Yuu SATO, Hitachinaka-shi, Ibaraki (JP)

(21) Appl. No.: 18/996,335

(22) PCT Filed: Aug. 7, 2023
(86) PCT No.: PCT/JP2023/028710

§ 371 Date: Jan. 17, 2025

(30) Foreign Application Priority Data
Sep. 5, 2022 (JP) 2022-140483

(51) Int. Cl. B60W 30/02; B60W 10/08; B60W 10/192; B60W 10/20; B60W 30/18; B60W 40/068; B60W 50/02; B60W 50/14; B62D 6/00

(52) U.S. Cl. CPC B60W 30/02; B60W 10/08; B60W 10/192; B60W 10/20; B60W 30/18127; B60W 40/068; B60W 50/0225; B60W 50/14; B62D 6/008; B60W 2510/202; B60W 2552/40; B60W 2710/083; B60W 2710/18; B60W 2710/202; B60W 2720/14

(57) ABSTRACT

When a vehicle has an abnormality that causes abnormal behavior of the vehicle when braking force is generated by a braking device, each of a vehicle control device, a vehicle control method, and a steering system according to the present invention calculates predicted behavior, which is behavior of the vehicle predicted to occur when the braking device is activated, and generates steering force in a direction to suppress the predicted behavior so that the vehicle behaves in accordance with the operation amount of a steering operation input member. This makes it possible to improve the stability of the vehicle.

### TECHNICAL FIELD

The present invention relates to a vehicle control device, to a vehicle control method, and to a steering system.

### BACKGROUND ART

A steering control device for a vehicle described in Patent Document 1 includes an assisting unit that assists steering based on steering torque. The steering control device detects actual braking force actually generated by a braking device of the vehicle, calculates a braking force difference between left actual braking force and right actual braking force, incorporates a steering correction amount based on the braking force difference in a steering assist amount calculated by the assisting unit, and thereby maintains vehicle stability even when an abnormality occurs in the braking device.

### REFERENCE DOCUMENT LIST

### Patent Document

Patent Document 1: JP 2006-213173 A

### SUMMARY OF THE INVENTION

### Problem to be Solved by the Invention

When a control device of a steering system controls steering force based on the difference in braking force actually generated by a braking device between the left and right sides of a vehicle, it is difficult to maintain vehicle stability because the steering force is controlled after a yaw moment is actually generated due to the difference in braking force between the left and right sides of the vehicle.

The present invention has been made in view of the above circumstances, and an object of the present invention is to provide a vehicle control device, a vehicle control method, and a steering system that can improve vehicle stability even in the presence of an abnormality that causes a yaw moment when braking force is generated by a braking device.

### Means for Solving the Problem

According to an aspect of the present invention, when a vehicle has an abnormality that causes abnormal behavior of the vehicle when braking force is generated by a braking device, predicted behavior, which is behavior of the vehicle predicted to occur when the braking device is activated, is calculated, and steering force is generated in a direction to suppress the predicted behavior so that the vehicle behaves in accordance with the operation amount of a steering operation input member.

### Effects of the Invention

The present invention makes it possible to improve vehicle stability even in the presence of an abnormality that causes a yaw moment when braking force is generated by a braking device.

### BRIEF DESCRIPTION OF THE DRAWINGS

FIG. 1 is a diagram illustrating configurations of a braking device and a steering system of a vehicle.

FIG. 2 is a flowchart illustrating a control operation of the braking device.

FIG. 3 is a flowchart illustrating a control operation of the steering system.

FIG. 4 is a state diagram for describing the generation of a yaw moment due to an abnormality in the braking device.

FIG. 5 is a control block diagram of the braking device and the steering system.

FIG. 6 is a timing chart showing changes in a steering angle, reaction torque, and other factors in a braking state.

FIG. 7 is a flowchart illustrating a control operation of the steering system considering the friction coefficient of a road surface.

FIG. 8 is a flowchart illustrating a control operation of the braking device including a process of changing braking force distribution.

FIG. 9 is a timing chart showing changes in braking force on respective wheels, a steering angle, reaction torque, and other factors in a braking state.

### MODE FOR CARRYING OUT THE INVENTION

A vehicle control device, a vehicle control method, and a steering system according to an embodiment of the present invention are described with reference to the drawings.

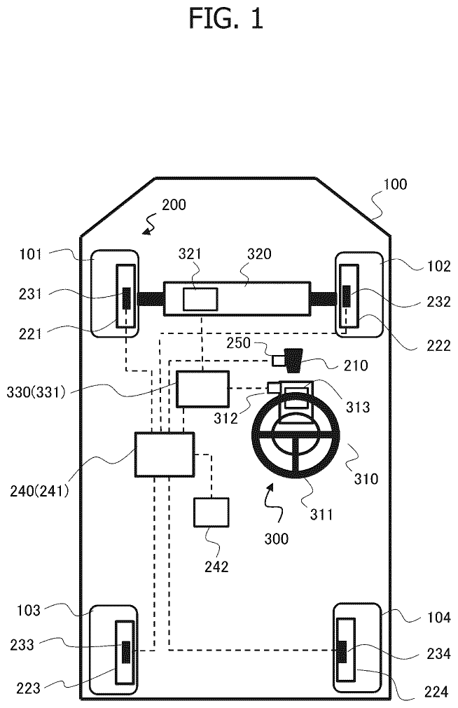

FIG. 1 is a schematic diagram illustrating an example of a vehicle 100.

Vehicle 100 is a four-wheeled automobile including a pair of left and right front wheels 101 and 102 and a pair of left and right rear wheels 103 and 104.

Vehicle 100 also includes a braking device 200 and a steer-by-wire steering system 300.

Braking device 200 includes a brake pedal 210 operated by the driver of vehicle 100 and brake actuators 221-224 provided, respectively, for wheels 101-104.

Braking device 200 is an electric braking device in which brake pedal 210 is not physically connected to brake actuators 221-224 and that can independently control the braking force on four wheels 101-104.

Each of brake actuators 221-224 is a mechanism that generates braking force by the operation of a motor and is, for example, an electric caliper that generates frictional force by driving a motor.

Also, braking device 200 may be implemented as a regenerative braking device that generates braking force on each of wheels 101-104 by using the regenerative operation of an in-wheel motor provided in each of wheels 101-104.

In addition to brake pedal 210 and brake actuators 221-224, braking device 200 includes brake thrust sensors 231-234 provided in corresponding brake actuators 221-224, a brake control unit 240 that outputs a control signal to each of brake actuators 221-224, and a brake pedal sensor 250 that detects the operation amount of brake pedal 210.

Brake control unit 240 is a vehicle control device that is primarily comprised of a microcomputer 241.

Microcomputer 241 includes a microprocessor unit (MPU), a read-only memory (ROM), and a random access memory (RAM) and has a function of a controller that controls the braking force generated by each of brake actuators 221-224 according to the operation amount of brake pedal 210.

Microcomputer 241 obtains a signal indicating the operation amount (in other words, stroke amount) of brake pedal 210 output by brake pedal sensor 250.

Also, microcomputer 241 obtains signals that are output by brake thrust sensors 231-234 and indicate the thrust generated by respective brake actuators 221-224.

Microcomputer 241 independently controls the motors of brake actuators 221-224 based on, for example, the signal indicating the operation amount of brake pedal 210 and the signals indicating the thrust generated by respective brake actuators 221-224 and thereby independently controls the braking force applied to respective wheels 101-104.

Steering system 300 changes the steering angle of front wheels 101 and 102, which are steered road wheels, based on the operation amount of a steering wheel 311, which is a steering operation input member operated by the driver of vehicle 100.

Steering system 300 is a steer-by-wire steering system in which steering wheel 311 is not physically connected to front wheels 101 and 102 and that can control the steering angle of front wheels 101 and 102 independently of the operation amount of steering wheel 311.

Steering system 300 includes a steering operation input device 310 including steering wheel 311, a steering device 320 including a steering actuator 321 that applies steering force to front wheels 101 and 102, and a steering control unit 330.

In addition to steering wheel 311, steering operation input device 310 includes an operation amount sensor 312 that detects the operation amount of steering wheel 311 and a reaction force actuator 313 that applies operation reaction force to steering wheel 311.

Steering control unit 330 is a vehicle control device that is primarily comprised of a microcomputer 331.

Microcomputer 331 includes an MPU, a ROM, and a RAM and functions as a controller that outputs a control signal to steering actuator 321 based on, for example, a signal indicating an operation amount of steering wheel 311.

Microcomputer 331 of steering control unit 330 and microcomputer 241 of brake control unit 240 can communicate with each other via, for example, a controller area network (CAN) bus.

Microcomputer 331 obtains, for example, a signal output from operation amount sensor 312 and indicating an operation amount of steering wheel 311 and calculates a target steering angle of front wheels 101 and 102 and target reaction force to be applied to steering wheel 311 according to conditions when steering wheel 311 is operated.

Then, microcomputer 331 outputs a steering control signal obtained based on the target steering angle to steering actuator 321 to control the steering angle of front wheels 101 and 102 to match the target steering angle.

Also, microcomputer 331 outputs a reaction force control signal obtained based on the target reaction force to reaction force actuator 313 to control the reaction force applied to steering wheel 311 to match the target reaction force.

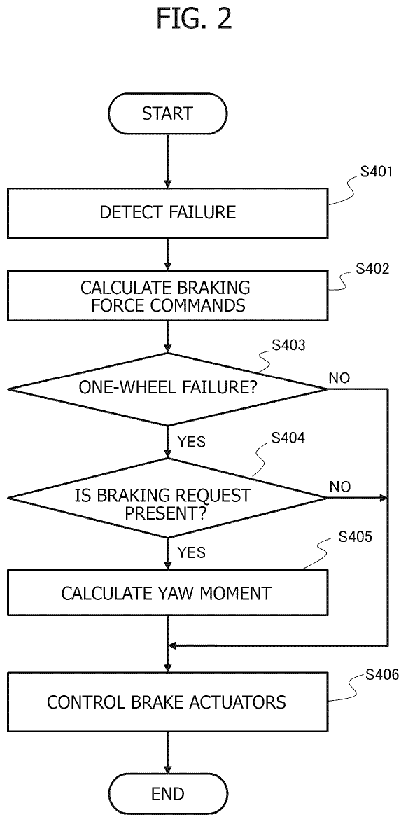

FIG. 2 is a flowchart illustrating a control operation performed by microcomputer 241 of brake control unit 240 to control braking device 200, in other words, a control method performed by microcomputer 241 to control braking device 200.

After starting a system operation, at step S401, microcomputer 241 first performs a process of determining whether an abnormality has been detected in braking device 200.

An abnormality in braking device 200 to be detected by microcomputer 241 at step S401 is an abnormality that causes a difference in braking force between the left and right sides of vehicle 100 when braking force is generated by braking device 200 and thereby causes a yaw moment on vehicle 100.

For example, the abnormality to be detected at step S401 may indicate that one of brake actuators 221-224 is in a failed state and cannot generate braking force or can generate only braking force that is less than normal.

When one of brake actuators 221-224 fails, a difference in braking force between the left and right wheels occurs when braking device 200 is activated, and as a result, a yaw moment is generated. This in turn causes abnormal behavior that differs from the vehicle behavior based on the operation amount of steering wheel 311, in other words, behavior of vehicle 100 to deviate from a target trajectory.

Microcomputer 241 can detect the failure of each of brake actuators 221-224 based on, for example, motor disconnection or motor inverter malfunction and can also detect the failure of each of brake actuators 221-224 based on a thrust detection result obtained when motor drive control is performed.

Furthermore, the abnormality to be detected at step S401 may be a state in which the tire of one of four wheels 101-104 is flat or has an air pressure lower than normal.

In other words, microcomputer 241 can detect a tire air pressure abnormality as one of the abnormalities of braking device 200.

When braking device 200 is activated while the tire of one of four wheels 101-104 is flat or has a low air pressure, a yaw moment is generated.

When vehicle 100 includes air pressure sensors for detecting the air pressures of the respective tires of four wheels 101-104, microcomputer 241 identifies a tire that is flat or has a low air pressure based on signals from the air pressure sensors and detects this event as an abnormality that causes a yaw moment in braking.

After determining at step S401 whether an abnormality has been detected in braking device 200, at next step S402, microcomputer 241 calculates braking force commands based on, for example, a signal indicating the operation amount of brake pedal 210.

Here, when vehicle 100 includes a warning device 242 (see FIG. 1) that warns the driver of vehicle 100 about the occurrence of an abnormality in braking device 200, microcomputer 241 may output an activation signal to activate warning device 242 when detecting the occurrence of an abnormality at step S401.

Warning device 242 is, for example, an audio guidance device, a warning lamp, a buzzer, or a liquid crystal display.

Next, at step S403, microcomputer 241 determines whether a one-wheel failure has been detected in braking device 200.

When a one-wheel failure has been detected in braking device 200, microcomputer 241 proceeds to step S404.

In other words, microcomputer 241 proceeds to step S404 when obtaining an abnormality detection signal indicating the occurrence of an abnormality that causes a yaw moment on vehicle 100 when braking force is generated by braking device 200.

At step S404, microcomputer 241 determines whether a braking request is present based on, for example, a signal indicating the operation amount of brake pedal 210.

Microcomputer 241 proceeds to step S405 when a one-wheel failure has been detected in braking device 200 and a braking request is present.

At step S405, microcomputer 241 calculates a predicted yaw moment that is predicted to be generated in vehicle 100 due to the difference in braking force between the left and right wheels caused by the one-wheel failure in braking device 200.

Here, even when the tire of one wheel is flat, similarly to the case in which a one-wheel failure occurs in braking device 200, microcomputer 241 proceeds to step S405 and calculates a yaw moment that is predicted to be generated in braking.

Then, microcomputer 241 transmits a signal indicating the predicted yaw moment calculated at step S405 to microcomputer 331 of steering control unit 330.

That is, when detecting the occurrence of an abnormality in braking device 200, microcomputer 241 calculates, as a predicted yaw moment, predicted behavior that is behavior of vehicle 100 predicted to occur when braking device 200 is activated.

After calculating and transmitting the predicted yaw moment (in other words, predicted behavior) at step S405, microcomputer 241 proceeds to step S406.

Also, when determining, at step S403, that a one-wheel failure has not been detected, microcomputer 241 bypasses steps S404 and S405 and proceeds to step S406.

Furthermore, when determining, at step S404, that no braking request is present, that is, when braking device 200 is in the one-wheel failure state but the braking request is not present, microcomputer 241 bypasses step S405 and proceeds to step S406.

At step S406, microcomputer 241 controls brake actuators 221-224 based on the braking force commands calculated at step S402.

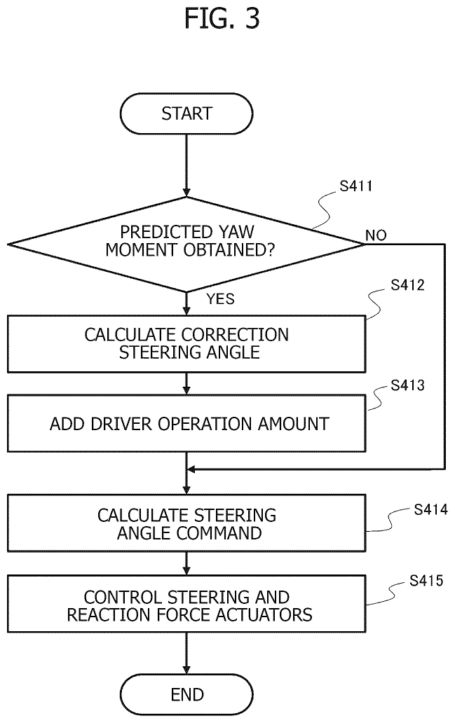

FIG. 3 is a flowchart illustrating a control operation performed by microcomputer 331 of steering control unit 330 to control steering system 300, in other words, a control method performed by microcomputer 331 to control steering system 300.

After starting a system operation, at step S411, microcomputer 331 first determines whether a signal indicating the predicted yaw moment has been obtained from microcomputer 241 of brake control unit 240.

The state in which microcomputer 331 has obtained the signal indicating the predicted yaw moment corresponds to the state in which a one-wheel failure has occurred in braking device 200, a request for activating braking device 200 is present, and the occurrence of a yaw moment (in other words, abnormal behavior of vehicle 100) due to the difference in braking force between the left and right wheels is predicted.

When the signal indicating the predicted yaw moment has not been obtained, microcomputer 331 bypasses steps S412 and S413 and proceeds to step S414.

On the other hand, when the signal indicating the predicted yaw moment has been obtained, microcomputer 331 proceeds to step S412.

At step S412, microcomputer 331 calculates a correction steering angle for suppressing the predicted yaw moment (in other words, abnormal behavior) and also calculates correction reaction torque that causes steering wheel 311 to move to a position corresponding to the vehicle behavior caused by the predicted yaw moment.

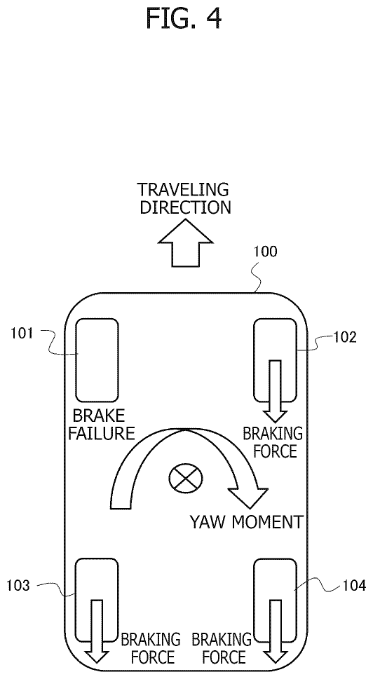

FIG. 4 is a diagram for describing that a yaw moment of vehicle 100 is generated due to a one-wheel failure in braking device 200.

In the example of FIG. 4, while brake actuators 222-224 for right front wheel 102 and left and right rear wheels 103 and 104 are normal, brake actuator 221 for left front wheel 101 is in a failed state and cannot generate braking force.

When braking device 200 is activated while braking device 200 is in an abnormal state (specifically, while left front wheel 101 is in a failed state), although normal braking force is applied to right front wheel 102 and left and right rear wheels 103 and 104, the braking force applied to left front wheel 101 is less than the braking force (in other words, the normal braking force) applied to right front wheel 102.

As a result, a difference in braking force between left front wheel 101 and right front wheel 102 occurs, and a yaw moment in a right-turn direction of vehicle 100 is generated.

That is, when brake actuator 221 for left front wheel 101 is in a failed state, microcomputer 241 can predict that a yaw moment causing vehicle 100 to turn right is generated when braking device 200 is activated.

When obtaining a signal indicating a predicted yaw moment that causes vehicle 100 to turn right, microcomputer 331 performs feedforward control of correcting the steering angle of front wheels 101 and 102 so that front wheels 101 and 102 are pivoted more to the left than by the steering angle corresponding to the operation amount of steering wheel 311 and the right turn of vehicle 100 in braking is suppressed.

Also, in parallel with the feedforward control of the steering angle of front wheels 101 and 102, microcomputer 331 obtains correction reaction torque that causes steering wheel 311 to rotate in the direction of the yaw moment caused by the one-wheel failure of braking device 200, e.g., in the right direction when brake actuator 221 of left front wheel 101 is in the failed state.

Next, at next step S413, microcomputer 331 adds, to the correction steering angle and the correction reaction torque calculated at step S412, values corresponding to, for example, the amount of operation of steering wheel 311 performed by the driver.

At step S414, microcomputer 331 calculates a steering angle command value and a reaction torque command value based on the calculation results at step S413. Then, at step S415, microcomputer 331 controls steering actuator 321 based on the steering angle command value and controls reaction force actuator 313 based on the reaction torque command value.

On the other hand, when the signal indicating the predicted yaw moment has not been obtained, microcomputer 331 bypasses steps S412 and S413 and proceeds to step S414 to normally control steering actuator 321 and reaction force actuator 313 based on a steering angle command value and a reaction torque command value corresponding to, for example, the amount of operation of steering wheel 311 performed by the driver.

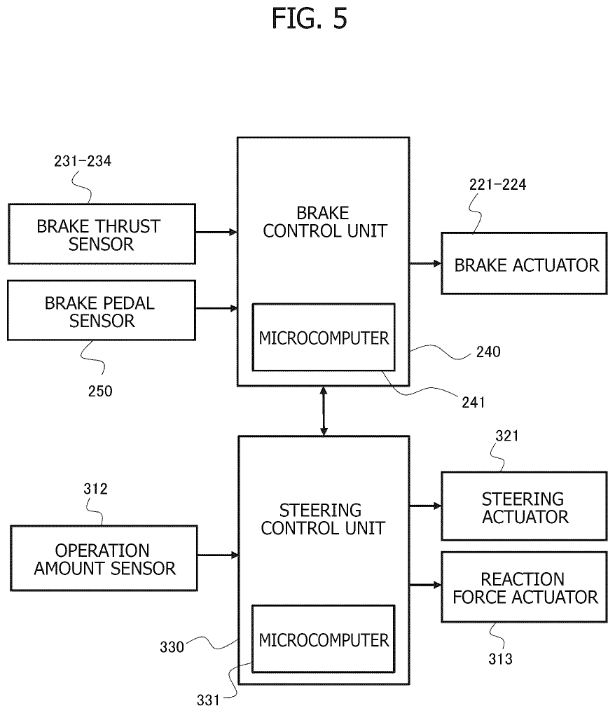

FIG. 5 is a block diagram illustrating basic components related to the control of braking device 200 and steering system 300.

Microcomputer 241 of brake control unit 240 obtains brake thrust detection signals output by brake thrust sensors 231-234 and a pedal operation amount detection signal output by brake pedal sensor 250.

Based on the obtained signals, microcomputer 241 calculates a predicted yaw moment predicted to be generated as a result of braking in the one-wheel failure state of braking device 200 and also calculates command values for brake actuators 221-224.

Microcomputer 241 transmits a signal indicating the calculated predicted yaw moment to microcomputer 331 of steering control unit 330.

Also, microcomputer 241 controls brake actuators 221-224 based on the calculated command values for brake actuators 221-224.

On the other hand, microcomputer 331 of steering control unit 330 obtains, for example, an operation amount detection signal of steering wheel 311 output by operation amount sensor 312 and also obtains a signal indicating the predicted yaw moment from brake control unit 240.

Then, under a condition in which the predicted yaw moment is expected to be generated (i.e., when braking is performed in the one-wheel failure state), microcomputer 331 calculates a steering angle command and a reaction torque command such that the predicted yaw moment is suppressed and vehicle behavior based on the operation amount of steering wheel 311 is achieved.

Also, under a condition in which no abnormality is present in braking device 200 and no predicted yaw moment is expected to be generated, microcomputer 331 normally calculates a steering angle command and a reaction torque command corresponding to the operation amount of steering wheel 311.

Then, microcomputer 331 controls steering actuator 321 based on the steering angle command and controls reaction force actuator 313 based on the reaction torque command.

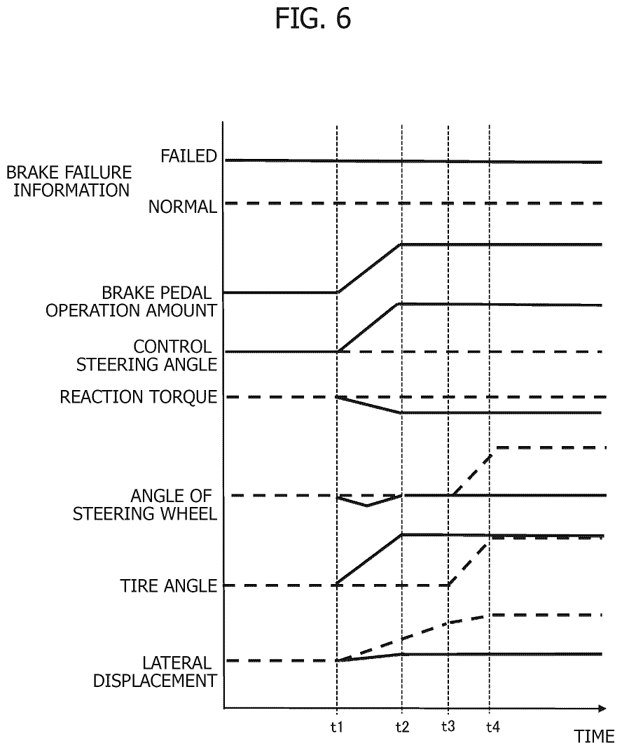

FIG. 6 is a timing chart showing an example of a control operation of steering system 300 based on the predicted yaw moment.

FIG. 6 shows a control operation based on an assumption that the driver performs a brake operation while braking device 200 is in the one-wheel failure state and vehicle 100 is traveling in a straight line.

The driver starts a deceleration operation, i.e., a pressing operation of brake pedal 210, at time t1 when vehicle 100 is traveling in a straight line at a constant speed, continues to further press brake pedal 210 (in other words, to increase the operation amount of brake pedal 210) from time t1 to time t2, and keeps the pressing amount (operation amount) of brake pedal 210 constant from time t3 onward.

In FIG. 6, dotted lines indicate a steering operation performed with a steering mechanism in which steering wheel 311 is physically connected to front wheels 101 and 102. When braking device 200 is in the one-wheel failure state, a difference in braking force between the left and right sides of vehicle 100 occurs in braking and as a result, a yaw moment is generated. This in turn causes lateral displacement of vehicle 100.

In the case of a steering mechanism in which steering wheel 311 is physically connected to front wheels 101 and 102, the driver can recognize the occurrence of the lateral displacement based on the movement of steering wheel 311 resulting from the lateral displacement.

In contrast, in the case of steer-by-wire steering system 300, because steering wheel 311 is not physically connected to front wheels 101 and 102, even when lateral displacement of vehicle 100 occurs, no rotational force resulting from the lateral displacement is applied to steering wheel 311.

Therefore, the driver recognizes the occurrence of unintended lateral displacement resulting from a brake failure (the occurrence of a difference in braking force between the left and right sides) at time t3 when the lateral displacement of vehicle 100 reaches a certain level and then operates steering wheel 311 in a direction to suppress the yaw behavior of vehicle 100. As a result, the motion of vehicle 100 is stabilized at time t4.

On the other hand, with the configuration in which steering control unit 330 performs feedforward control on steering system 300 based on a predicted yaw moment, steering control unit 330 starts the feedforward control from time t1, at which the driver starts a brake operation, to correct the steering angle of front wheels 101 and 102 in a direction to suppress the predicted yaw moment.

This makes it possible to suppress the increase in lateral displacement and quickly stabilize vehicle 100 even if a difference in braking force between the left and right wheels occurs due to a failure in braking device 200.

Steering control unit 330 can set a correction value for the steering angle of front wheels 101 and 102 (in other words, a correction value for the steering force generated by steering actuator 321) that is smaller than a value necessary to cancel the predicted yaw moment so that the driver still needs to perform a corrective operation of steering wheel 311. With this configuration, because the driver needs to perform a steering operation to correct the lateral displacement of vehicle 100 in braking, the driver can intuitively recognize a failure (specifically, a one-wheel failure) in braking device 200.

Also, steering control unit 330 can enable the driver to intuitively recognize a failure (specifically, a one-wheel failure) in braking device 200 by applying correction reaction torque that causes steering wheel 311 to rotate in the direction of the yaw moment resulting from the one-wheel failure in braking device 200.

Here, when lateral displacement occurs due to a difference in braking force between the left and right wheels in a steering mechanism in which steering wheel 311 is physically connected to front wheels 101 and 102, steering wheel 311 rotates.

To simulate such a rotation of steering wheel 311 in steer-by-wire steering system 300, steering control unit 330 causes reaction force actuator 313 to generate force that rotates steering wheel 311 in the direction of the predicted yaw moment.

Also, by setting a correction value for the steering angle of front wheels 101 and 102 that is smaller than a value necessary to cancel the predicted yaw moment and applying rotational force to the steering wheel 311 in the direction of the predicted yaw moment, it is possible to suppress yaw behavior in a situation in which the yaw behavior is expected to occur due to the difference in braking force between the left and right sides of vehicle 100 and to give the driver steering feel that is close to that of a steering mechanism in which the steering wheel 311 is physically connected to front wheels 101 and 102. This in turn enables the driver to easily recognize a situation in which a yaw moment occurs due to a difference in braking force between the left and right sides of vehicle 100.

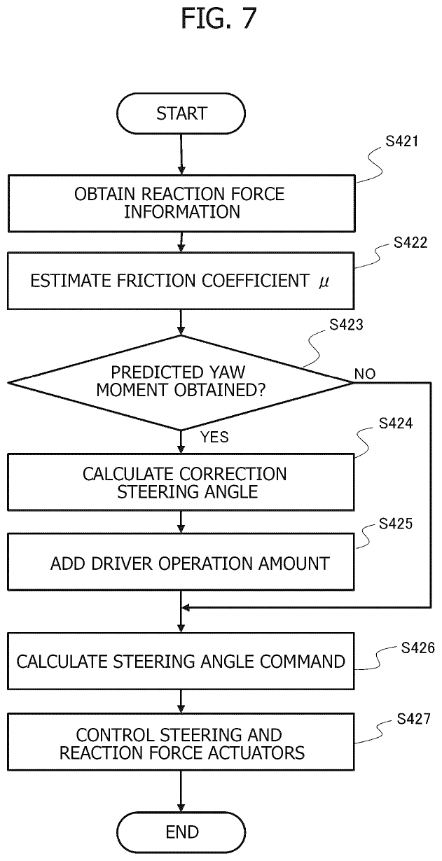

FIG. 7 is a flowchart illustrating another example of a control operation performed by microcomputer 331 of steering control unit 330 to control steering system 300.

Here, microcomputer 331 includes a function that obtains a friction coefficient signal related to a friction coefficient u of a road surface on which vehicle 100 travels and changes a correction steering angle (in other words, steering force) for suppressing a predicted yaw moment according to the friction coefficient μ of the road surface.

After starting a system operation, at step S421, microcomputer 331 first obtains, from steering device 320, information on reaction force, specifically, information on self-aligning torque that is received by front wheels 101 and 102 from the road surface.

Next, at step S422, microcomputer 331 estimates a friction coefficient u of the road surface on which vehicle 100 travels based on the information on the self-aligning torque.

That is, microcomputer 331 has a function as a friction coefficient estimation unit that estimates the friction coefficient u of the road surface based on the information on self-aligning torque.

For example, a method disclosed in JP 2003-341502 A may be used to estimate the friction coefficient u based on the information on self-aligning torque.

However, a signal related to friction coefficient u is not necessarily obtained by estimation based on the information on self-aligning torque.

For example, microcomputer 331 may obtain information related to friction coefficient μ from the outside of vehicle 100 via road-to-vehicle communication.

The information related to friction coefficient u includes information on weather, such as rainfall and accumulation of snow, while vehicle 100 is traveling.

Next, at step S423, microcomputer 331 determines whether a signal indicating a predicted yaw moment has been obtained from microcomputer 241 of brake control unit 240. When the signal indicating the predicted yaw moment has not been obtained, microcomputer 331 bypasses steps S424 and S425 and proceeds to step S426. When the signal indicating the predicted yaw moment has been obtained, microcomputer 331 proceeds to step S424.

At step S424, microcomputer 331 calculates a correction steering angle for suppressing the predicted yaw moment and also calculates correction reaction torque that causes steering wheel 311 to move to a position corresponding to vehicle behavior caused by the predicted yaw moment.

Microcomputer 331 decreases the maximum value (in other words, the upper limit) of the correction steering angle as estimated friction coefficient μ decreases and the road surface on which vehicle 100 travels becomes more slippery.

With this configuration, microcomputer 331 can prevent the correction steering angle (in other words, the correction steering force) from becoming excessively large when friction coefficient u is smaller than normal and can set the correction steering angle appropriately even when friction coefficient u changes.

Also, when setting the correction steering angle based on the predicted yaw moment, microcomputer 331 can correct the predicted yaw moment used for setting the correction steering angle to a smaller value as the friction coefficient μ becomes smaller.

In other words, microcomputer 331 can decrease the control gain of the correction steering angle for the predicted yaw moment calculated by microcomputer 241 of brake control unit 240 as friction coefficient μ becomes smaller than normal.

At step S425, microcomputer 331 adds, to the correction steering angle and the correction reaction torque calculated at step S424, values corresponding to the amount of operation of steering wheel 311 performed by the driver.

Next, at step S426, microcomputer 331 calculates a steering angle command value and a reaction torque command value based on the calculation results of step S425.

At step S427, microcomputer 331 controls steering actuator 321 based on the steering angle command value and controls reaction force actuator 313 based on the reaction torque command value.

On the other hand, when determining, at step S423, that the signal indicating the predicted yaw moment has not been obtained, microcomputer 331 bypasses steps S424 and S425 and proceeds to step S426 to normally control steering actuator 321 and reaction force actuator 313 based on a steering angle command value and a reaction torque command value corresponding to the amount of operation of steering wheel 311 performed by the driver.

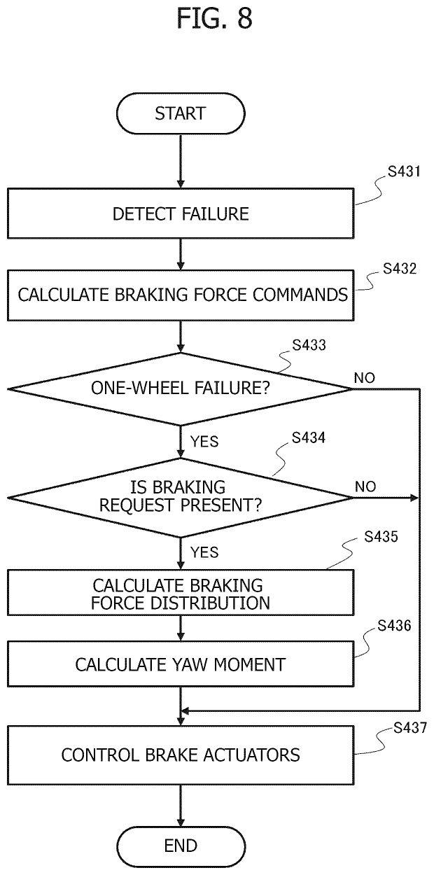

FIG. 8 is a flowchart illustrating another example of a control operation performed by microcomputer 241 of brake control unit 240 to control braking device 200.

Here, when a one-wheel failure occurs in braking device 200, microcomputer 241 changes the distribution of braking force for the remaining three wheels such that the yaw moment resulting from the one-wheel failure decreases, that is, the difference in braking force between the left and right sides of vehicle 100 decreases.

Then, microcomputer 241 calculates, as a predicted yaw moment, a yaw moment that is predicted to occur when the braking force distribution is changed.

Here, steps S431 to S434 in the flowchart of FIG. 8 are the same as steps S401 to S404 in the flowchart of FIG. 2, and therefore, detailed descriptions of these steps are omitted.

Microcomputer 241 proceeds to step S435 when braking device 200 is in a one-wheel failure state and a braking request is present.

At step S435, microcomputer 241 calculates braking force distribution for three wheels that have not failed based on braking force commands calculated at step S432 and information on the failed wheel in braking device 200 such that the yaw moment generated in braking becomes smaller than the yaw moment generated with the normal braking force distribution. Also, microcomputer 241 calculates braking force commands for the three wheels based on the calculated braking force distribution.

Here, in the one-wheel failure state of the braking device 200, microcomputer 241 can change the braking force distribution such that the yaw moment generated in braking is minimized but the deceleration of vehicle 100 is maintained.

For example, when brake actuator 221 of left front wheel 101 in braking device 200 is in a failed state and cannot generate braking force, microcomputer 241 increases the braking force to be generated by brake actuator 223 of left rear wheel 103 by the amount of braking force that is supposed to be generated by brake actuator 221.

That is, when brake actuator 221 of left front wheel 101 fails, microcomputer 241 calculates the braking force command for the left rear wheel 103 by adding the requested braking force for left front wheel 101 to the requested braking force for left rear wheel 103.

On the other hand, the braking force distribution for the right front wheel 102 and the right rear wheel 104 is not changed and is maintained at a normal value.

By changing the braking force distribution as described above, the braking force applied to the left side of vehicle 100 becomes equal to the braking force applied to the right side of vehicle 100, and the yaw moment of vehicle 100 generated upon activation of braking device 200 is reduced.

Next, microcomputer 241 proceeds to step S436, calculates a predicted yaw moment that is predicted to be generated in braking with the braking force distribution (in other words, the braking force commands) calculated at step S435, and transmits information indicating the calculated predicted yaw moment to microcomputer 331 of steering control unit 330.

At step S437, microcomputer 241 controls brake actuators 221-224 based on the braking force commands.

When the braking device 200 is in the one-wheel failure state, microcomputer 241 controls brake actuators 221-224 based on the braking force commands calculated at step S435, that is, the braking force commands calculated after the braking force distribution is changed.

On the other hand, when braking device 200 is not in the one-wheel failure state, microcomputer 241 controls brake actuators 221-224 based on the braking force commands calculated at step S432, that is, the braking force commands in the normal braking force distribution.

As described above, even when braking device 200 is in the one wheel failure state, it is possible to stably suppress a yaw moment resulting from a difference in braking force between the left and right sides of vehicle 100 from the start of a braking operation and maintain the stability of vehicle 100 by changing the braking force distribution to reduce the yaw moment resulting from the difference in braking force and also correcting the steering angle to suppress the yaw moment resulting from the difference in braking force.

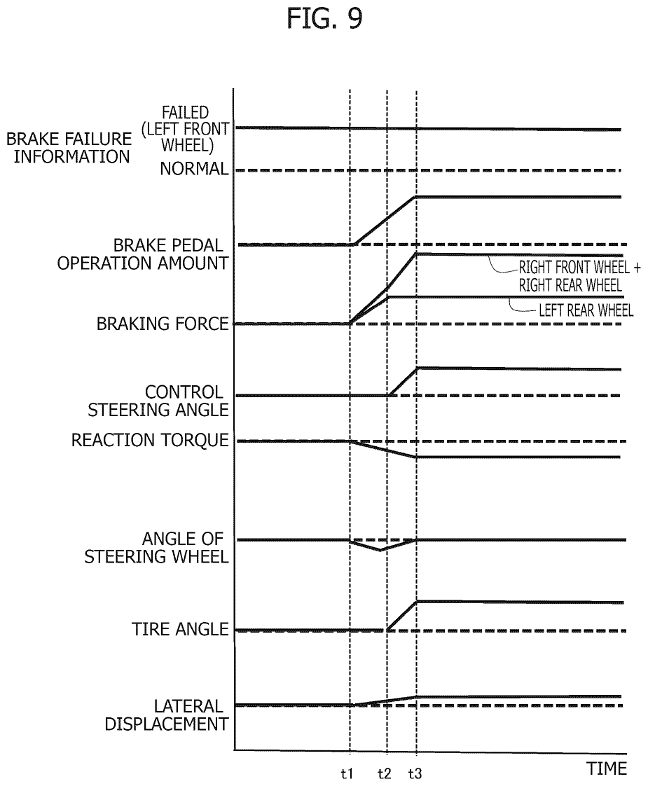

FIG. 9 is a timing chart showing an example of a control operation including the process of changing the braking force distribution described above.

Specifically, FIG. 9 shows changes in braking force, a steering angle, etc., when the driver performs a braking operation, i.e., operates brake pedal 210, while vehicle 100 is traveling in a straight line with failed brake actuator 221 of left front wheel 101 of braking device 200.

Here, it is assumed that microcomputer 241 of brake control unit 240 performs a braking force distribution process of adding the requested braking force for left front wheel 101 to the requested braking force for left rear wheel 103 to reduce a yaw moment generated in braking.

In FIG. 9, at time t1 when vehicle 100 is traveling in a straight line, the driver starts operating brake pedal 210.

Microcomputer 241 of brake control unit 240 changes the braking force distribution for the normal three wheels according to requested braking force corresponding to the operation amount of brake pedal 210 to generate requested deceleration while suppressing the yaw moment resulting from a difference in braking force.

That is, at and after time t1 when braking is started, microcomputer 241 adds a value corresponding to the braking force command for left front wheel 101 to the braking force command for left rear wheel 103 to make the braking force applied to the left side of vehicle 100 (specifically, the braking force on left rear wheel 103) equal to the braking force applied to the right side of vehicle 100 (specifically, braking force on right front wheel 102+braking force on right rear wheel 104) and thereby suppress the yaw moment generated in braking.

At the same time, microcomputer 331 of steering control unit 330 applies reaction torque to steering wheel 311 to cause steering wheel 311 to move to a position corresponding to vehicle behavior caused by the predicted yaw moment so that the steering angle of steering wheel 311 (or the reaction force of steering wheel 311) changes to enable the driver to intuitively notice the failure of braking device 200.

At time t2 when brake pedal 210 is being pressed by the driver, the braking force on left rear wheel 103 saturates. Thereafter, the braking force on the right front wheel 102 and the right rear wheel 104 is increased to generate deceleration.

That is, because the requested braking force for the left front wheel 101 is also applied to left rear wheel 103, the maximum braking force that can be generated by brake actuator 223 of left rear wheel 103 is reached at time t2. Therefore, brake actuator 223 cannot keep up with the increase in the requested braking force at and after time t2 and maintains the maximum braking force on left rear wheel 103.

On the other hand, because the braking force on each of right front wheel 102 and right rear wheel 104 has not reached the maximum braking force at time t2, the braking force on each of right front wheel 102 and right rear wheel 104 is increased in response to the increase in the requested braking force at and after time t2.

Thus, at and after time t2, while the total braking force on right front wheel 102 and right rear wheel 104 increases, the braking force on left rear wheel 103 reaches the maximum value and saturates, resulting in a difference in braking force between the left and right sides of vehicle 100.

Therefore, steering control unit 330 changes the steering angle (steering force) of front wheels 101 and 102 in a direction to reduce the predicted yaw moment calculated by brake control unit 240 and thereby suppresses the yaw moment of vehicle 100 generated at and after time t2 during which the difference in braking force between the left and right sides increases.

At time t3, the driver keeps the operation amount of brake pedal 210 constant and requests a constant deceleration.

In this case, achieving the deceleration requested by the driver results in a difference in braking force between the left and right sides of vehicle 100. However, because steering control unit 330 controls the steering angle, the driver can decelerate vehicle 100 without causing a yaw moment and with steering wheel 311 kept near the neutral position.

The technical concepts described in the above embodiments may be used in any appropriate combination as long as they do not conflict with each other.

Although the present invention is specifically described above with reference to preferred embodiments, it is apparent to one skilled in the art that variations of the embodiments can be made based on the basic technical concepts and the teachings of the present invention.

In the above embodiments, microcomputer 241 of brake control unit 240 calculates a predicted yaw moment. However, microcomputer 331 of steering control unit 330 may calculate a predicted yaw moment by obtaining, for example, information on a failure in braking device 200 and information on braking requests.

Also, the present invention may be applied to a system in which one control unit outputs control signals to both of braking device 200 and steering system 300.

Also, steering system 300 may separately include a control unit that outputs control signals to steering actuator 321 and a control unit that outputs control signals to reaction force actuator 313.

Furthermore, steering system 300 may include a backup mechanism that mechanically connects steering wheel 311 to front wheels 101 and 102 using, for example, a clutch.

### REFERENCE SYMBOL LIST

100 . . . vehicle, 101-104 . . . wheel, 200 . . . braking device, 240 . . . brake control unit (vehicle control device), 241 . . . microcomputer (controller), 300 . . . steer-by-wire steering system, 311 . . . steering wheel (steering operation input member), 320 . . . steering device, 321 . . . steering actuator, 330 . . . steering control unit (vehicle control device), 331 . . . microcomputer (controller)

1. A vehicle control device for a vehicle, the vehicle including:
a braking device that generates braking force for each wheel of the vehicle; and
a steer-by-wire steering system that includes a steering operation input member and a steering device including a steering actuator that applies steering force to steered road wheels of the vehicle, the steer-by-wire steering system being configured to control a steering angle of the steered road wheels independently of an operation amount of the steering operation input member,
the vehicle control device comprising:
a controller that outputs a control signal to the steering actuator based on the operation amount of the steering operation input member, wherein
the controller
obtains an abnormality detection signal indicating whether the vehicle has an abnormality that causes abnormal behavior of the vehicle when the braking force is generated by the braking device,
when occurrence of the abnormality is detected based on the abnormality detection signal, calculates predicted behavior, which is behavior of the vehicle predicted to occur when the braking device is activated, and
outputs the control signal to the steering actuator to generate the steering force in a direction to suppress the predicted behavior so that the vehicle behaves in accordance with the operation amount of the steering operation input member when the braking device is activated.

2. The vehicle control device according to claim 1, wherein the controller outputs the control signal to generate the steering force in the direction to suppress the predicted behavior such that the generated steering force is smaller than steering force required to cancel the predicted behavior.

3. The vehicle control device according to claim 2, wherein the controller sets the predicted behavior as a yaw moment that is predicted to be generated on the vehicle when the braking device is activated.

4. The vehicle control device according to claim 2, wherein
the steering system further includes a reaction force actuator that applies operation reaction force to the steering operation input member; and
when outputting the control signal to generate the steering force that is smaller than the steering force required to cancel the predicted behavior, the controller outputs a reaction force control signal to the reaction force actuator to move the steering operation input member to a position corresponding to the behavior of the vehicle.

5. The vehicle control device according to claim 1, wherein the controller obtains a friction coefficient signal related to a friction coefficient of a road surface on which the vehicle travels and, based on the friction coefficient signal, changes the steering force generated in the direction to suppress the predicted behavior.

6. The vehicle control device according to claim 5, wherein the controller includes a friction coefficient estimation unit that calculates the friction coefficient signal based on self-aligning torque applied to the steering device.

7. The vehicle control device according to claim 1, wherein
the vehicle includes a warning device that warns the occurrence of the abnormality; and
when detecting the occurrence of the abnormality, the controller outputs an activation signal that activates the warning device.

8. The vehicle control device according to claim 1, wherein the braking device is an electric braking device that generates braking force by operation of a motor.

9. The vehicle control device according to claim 8, wherein the electric braking device is an electric caliper that is disposed on each wheel of the vehicle and generates frictional force by driving the motor.

10. The vehicle control device according to claim 8, wherein the electric braking device is a regenerative braking device that generates the braking force on each wheel of the vehicle by a regenerative operation of an in-wheel motor disposed in each wheel of the vehicle.

11. The vehicle control device according to claim 1, wherein the abnormality detection signal indicates whether the abnormality is present in the braking device.

12. The vehicle control device according to claim 11, wherein when detecting the occurrence of the abnormality in the braking device, the controller changes distribution of the braking force for each wheel of the vehicle so that a yaw moment to be generated on the vehicle due to the abnormality in the braking device is reduced and calculates the predicted behavior in a condition in which the distribution of the braking force has been changed.

13. A vehicle control method performed by a controller of a vehicle, the vehicle including:
a braking device that generates braking force on each wheel of the vehicle; and
a steer-by-wire steering system that includes a steering operation input member and a steering device including a steering actuator that applies steering force to steered road wheels of the vehicle, the steer-by-wire steering system being configured to control a steering angle of the steered road wheels independently of an operation amount of the steering operation input member,
the controller being configured to output a control signal to the steering actuator based on the operation amount of the steering operation input member,
the vehicle control method comprising:
obtaining an abnormality detection signal indicating whether the vehicle has an abnormality that causes abnormal behavior of the vehicle when the braking force is generated by the braking device;
when occurrence of the abnormality is detected based on the abnormality detection signal, calculating predicted behavior, which is behavior of the vehicle predicted to occur when the braking device is activated, and
outputting the control signal to the steering actuator to generate the steering force in a direction to suppress the predicted behavior so that the vehicle behaves in accordance with the operation amount of the steering operation input member when the braking device is activated.

14. A steer-by-wire steering system comprising:
a steering operation input member attachable to a vehicle;
a steering device including a steering actuator that applies steering force to steered road wheels of the vehicle; and
a controller that outputs a control signal to the steering actuator based on an operation amount of the steering operation input member, wherein
the steer-by-wire steering system is configured to control a steering angle of the steered road wheels independently of the operation amount of the steering operation input member; and
the controller
obtains an abnormality detection signal indicating whether the vehicle has an abnormality that causes abnormal behavior of the vehicle when braking force is generated by a braking device of the vehicle on each wheel of the vehicle,
when occurrence of the abnormality is detected based on the abnormality detection signal, calculates predicted behavior, which is behavior of the vehicle predicted to occur when the braking device is activated, and
outputs the control signal to the steering actuator to generate the steering force in a direction to suppress the predicted behavior so that the vehicle behaves in accordance with the operation amount of the steering operation input member when the braking device is activated.
